(19) United States
(12) Patent Application Publication
(10) Pub. No.: US 2014/0019216 A1
(43) Pub. Date: Jan. 16, 2014

(54) PAYMENT DEVICE WITH TAG INTERFACE FOR TRANSPORTATION FARE PROCESSING, TRANSPORTATION FARE PROCESSING METHOD OF PAYMENT DEVICE WITH TAG INTERFACE, AND RECORDING MEDIUM

(71) Applicant: Byung Yong JO, Seoul (KR)

(72) Inventor: Byung Yong JO, Seoul (KR)

(21) Appl. No.: 13/940,381

(22) Filed: Jul. 12, 2013

(30) Foreign Application Priority Data
Jul. 12, 2012 (KR) 10-2012-0076324

(51) Int. Cl. G06Q 20/14

(52) U.S. Cl. CPC G06Q 20/145
USPC 705/13

(57) ABSTRACT

Provided is a transportation fare processing method of a payment device with a tag interface, the method including executing an application on an operating system of the payment device, obtaining payment information from a payment means of a user using a communication interface supported by the payment device, processing a transaction performed by the payment means based on the payment information, in response to an execution of the application, and transmitting the processed transaction to a server.

### CROSS-REFERENCE TO RELATED APPLICATION(S)

This application claims the benefit of Korean Patent Application No. 10-2012-0076324, filed on Jul. 12, 2012, in the Korean Intellectual Property Office, the disclosure of which is incorporated herein by reference.

### BACKGROUND

1. Field

The present invention relates to a transportation fare processing system and method of a payment device with a tag interface, and more particularly, to a technology that provides a recharging and payment service for processing fares for transportation and distribution services.

2. Background

A transportation fare processing technology may be applied to provide a transportation card recharging and payment service to a user who uses transportation. A transportation fare processing system may include a transportation card of a user, a device to which the transportation card is tagged, and a center server. Hereinafter, the device to which the transportation card is tagged will be referred to as a payment device with a tag interface.

In the transportation fare processing system, a device to which a transportation card is tagged may be configured by applying exclusive firmware to an own central processing unit (CPU) and hardware. The exclusive firmware may include application software, a device driver, and a Linux kernel to which a porting process is applied or a software layer of a wince operating system.

A technology for processing a fare for a distribution service may be applied to provide a user with a service for recharging and payment associated with a fare for a distribution service. Hereinafter, the fare for the distribution service will be referred to as the distribution fare. A distribution fare processing system may include a transportation card of a user, and a device.

A communication scheme using smart devices to be applied to the transportation fare processing system and the distribution fare processing system may include a radio frequency identification (RFID) scheme, and a near field communication (NFC) scheme. The RFID scheme refers to a scheme of reading stored data from a device including a semiconductor chip using a radio frequency in a contactless manner. The NFC scheme is similar to the RFID scheme in that stored data may be recognized from a device including a semiconductor chip using a radio frequency in a contactless manner. However, the NFC scheme may perform bidirectional communication of reading and writing, and may be performable within a short distance, for example, 20 centimeters (cm).

### SUMMARY

According to an aspect of the present invention, there is provided a transportation fare processing method of a payment device with a tag interface, the method including executing an application on an operating system of the payment device, obtaining payment information from a payment means of a user using a communication interface supported by the payment device, processing a transaction performed by the payment means based on the payment information, in response to an execution of the application, and transmitting the processed transaction to a server.

The processing may include calculating a transportation fare based on a parameter applied to the application, and processing the transaction performed by the payment means based on the calculated transportation fare.

The parameter may include at least one of information on a basic unit fare with respect to a form of transportation, a discount rate for each type of user, a transfer discount policy, and a fare calculation rule.

The application may include at least one of a bus management system (BMS) component to provide vehicle scheduling information, a graphical user interface (GUI) component to provide a GUI for a driver, and a transaction processing component to process a fare.

The transaction processing component may calculate a fare based on information on a departure station and an arrival station of the user, and processes a transaction of the transportation fare.

The method may further include downloading a parameter requested by the application from a private application store via a public communication network, and applying the downloaded parameter to the application.

The method may further include generating an indicator to indicate that an update of the application is necessary.

The obtaining may include obtaining the payment information from the payment means, using a radio frequency identification (RFID) interface or a near field communication (NFC) interface.

The method may further include verifying a validity of the payment means based on the payment information.

The verifying may include one of verifying the validity of the payment means, using a secure application module (SAM) provided in the payment means to authenticate the payment means, and verifying the validity of the payment means through the server corresponding to the application.

The application may include a common payment processing library corresponding to different forms of transportation.

According to another aspect of the present invention, there is also provided a payment device with a tag interface for transportation fare processing, the device including an executor to execute an application on an operating system of the payment device, an obtainer to obtain payment information from a payment means of a user using a communication interface supported by the payment device, a processor to process a transaction performed by the payment means based on the payment information, in response to an execution of the application, and a transmitter to transmit the processed transaction to a server.

The processor may calculate a transportation fare based on a parameter applied to the application, and process the transaction performed by the payment means based on the calculated transportation fare.

The parameter may include at least one of information on a basic unit fare with respect to a form of transportation, a discount rate for each type of user, a transfer discount policy, and a fare calculation rule.

The device may further include a downloader to download a parameter requested by the application from a private application store via a public communication network, and the processor may apply the downloaded parameter to the application and process the transaction performed by the payment means using the application.

The application may include a common payment processing library corresponding to different forms of transportation.

The payment device may include at least one of a point of sale (POS) device, a smart phone, a smart tablet personal computer (PC), and a personal digital assistant (PDA) device.

The payment means of the user may include at least one of a transportation card, an NFC chip, and a radio frequency (RF) chip.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a transportation fare processing system according to a conventional art;

FIG. 2 is a diagram illustrating devices of a transportation fare processing system according to a conventional art;

FIG. 3 is a diagram illustrating a transportation fare processing system according to an embodiment of the present invention;

FIG. 4 is a flowchart illustrating a transportation fare processing method in a transportation fare processing system according to an embodiment of the present invention;

FIG. 5 is a diagram illustrating a configuration of an application installed in a payment device with a tag interface in a transportation fare processing system according to an embodiment of the present invention;

FIG. 6 is a diagram illustrating a distribution fare processing system according to an embodiment of the present invention; and

FIG. 7 is a block diagram illustrating a payment device with a tag interface according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Herein, a fare for a distribution service will be referred to as a distribution fare.

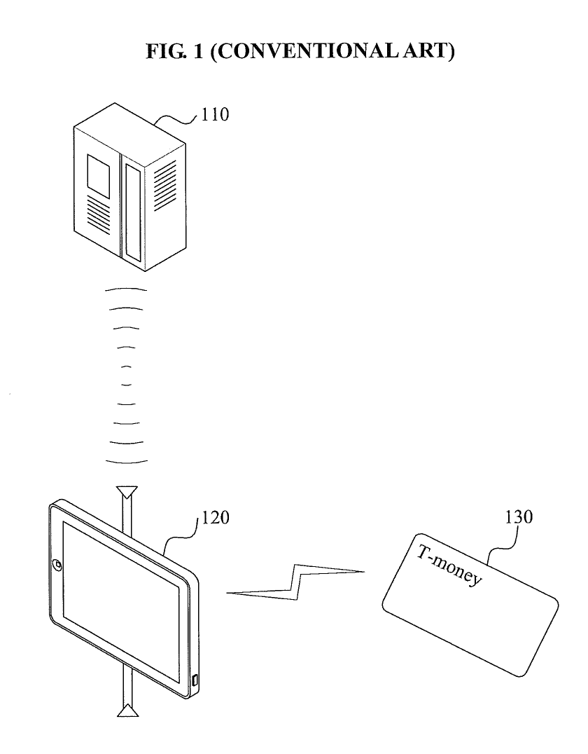

FIG. 1 is a diagram illustrating a transportation fare processing system according to a conventional art.

Referring to FIG. 1, the transportation fare processing system may include a center server 110, a device 120 of a service provider to which a transportation card 130 of a user is tagged, and the transportation card 130.

When the transportation card 130 is tagged to the device 120, information on the transportation card 130 may be obtained using a communication scheme supported by the device 120. A validity of the transportation card 130 may be verified based on the obtained information, and a balance of the transportation card 130 may be updated based on a result of the verifying. Such all transactions may be transmitted to the center server 110.

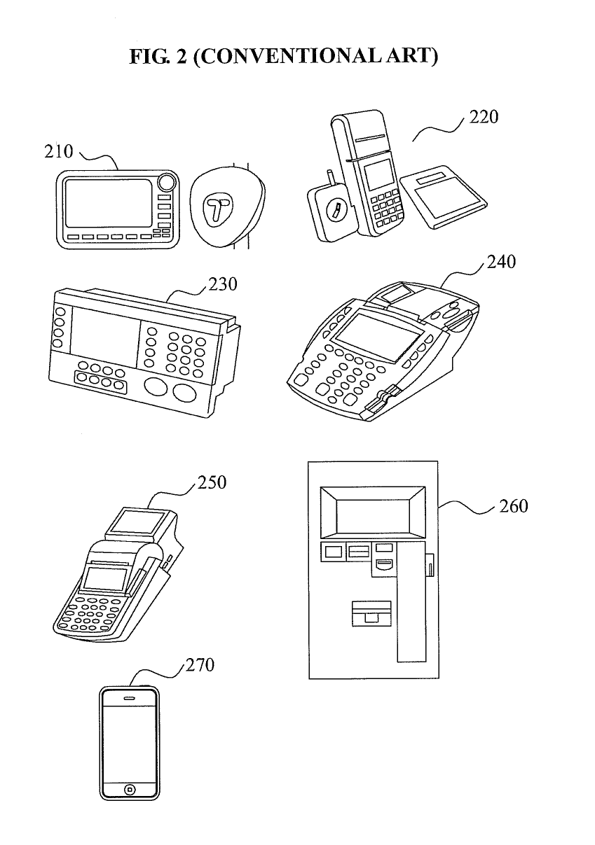

FIG. 2 is a diagram illustrating exclusive devices of a transportation fare processing system according to a conventional art.

Referring to FIG. 2, a T-money device 210 for a bus, a T-money device 220 for a taxi, a controller 230 for a bus driver provided by Cubic Corporation, and a controller 240 for a taxi driver provided by ACS, Inc. are illustrated. The conventional transportation fare processing system may use such exclusive devices.

An exclusive device may be configured by applying exclusive firmware to an own central processing unit (CPU) and hardware. Firmware of the exclusive device, for example, a conventional transportation fare processing device, may include application software, a device driver, and a Linux kernel to which a porting process is applied or a software layer of a wince operating system.

Although an operating system of the exclusive device is composed in a general-purpose programming language, the operating system may have a closed architecture such that a porting process of changing a source structure is to be performed for operation. Accordingly, for distribution and use of firmware updated due to a change in an environment of a service provider, an own network is to be established to distribute the firmware, and the porting process of changing the source structure of the operating system is to be performed again and thus, an expense for establishment and maintenance of a separate network may be incurred. In addition, a considerable time and expense may be required for developing, producing, installing, and distributing an own device. Without conducting a quality and durability test, issues about quality may arise continuously, and a persisting period may be relatively short.

In FIG. 2, a manned recharger 250, an unmanned recharger 260, and a distribution device 270 to be used for recharging, rather than payment in the transportation fare processing system are also illustrated. A recharger may be installed and operated separately from a device. However, the recharger may be identical to the device in that the recharger may include hardware, an own CPU, and firmware including a device driver, application software, and an operating system to which a porting process is applied. Accordingly, an exclusive recharger may incur an expense for establishment and maintenance of a separate network in order to distribute and use updated firmware. The distribution device 270 may transact with a smart device to provide a payment and recharging service through an access to an authentication server via a communication network. The distribution device 270 may authenticate a transportation card through an access to the authentication server, rather than using a security application module (SAM). Accordingly, an amount of time for a transaction may be relatively long, and a communication expense may be incurred.

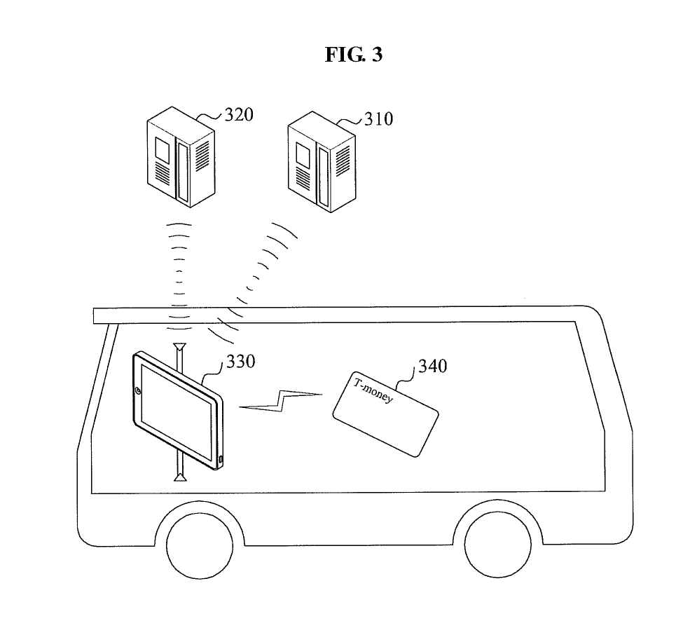

FIG. 3 is a diagram illustrating a transportation fare processing system according to an embodiment of the present invention.

Referring to FIG. 3, the transportation fare processing system may include a server 310, a private application store 320, a payment device 330 to which a payment means 340 of a user is tagged, and the payment means 340.

The payment device 330 of a service provider may perform a role as a device to which the payment means 340 is tagged, and may include smart devices, for example, a point of sale (POS) device, a smart phone, a smart tablet personal computer (PC), and a personal digital assistant (PDA) device. The payment device 330 may have a general-purpose mobile operating system, and an application may be installed on the general-purpose mobile operating system. For example, the application may include a bus application, a railroad application, a taxi application, and a boat application. Since the payment device 330 may include a network module using a public communication network, a separate network module may be unnecessary, in contrast to an exclusive device. Here, the public communication network refers to a network which a smart phone, a smart tablet PC, and the like may access. The public communication network may include, for example, a cellular network, a wireless-fidelity (Wi-Fi) network, and the like.

The payment means 340 may include a payment device with a tag interface including a transportation card, a near field communication (NFC) chip, or a radio frequency (RF) chip.

The private application store 320 may manage applications for i-phone operating system (iOS) or Android. The private application store 320 may allow pre-registered equipment to access, and manage an authority of use of all the registered equipment. A parameter requested by an application of the payment device 330 may be updated using the private application store 320. The parameter may include information on a basic unit fare, a discount rate for each type of user, a transfer discount policy, a fare calculation rule, and the like requested by the application.

When the payment device 330 and the private application store 320 are used, an expense and a time expended for developing, producing, and distributing an exclusive device may be reduced. In addition, the payment device 330 and the private application store 320 may be used in hardware adopting an identical platform, without additional correction. Updates may be performed using a public communication network and thus, a separate network module may be unnecessary. In addition, as global enterprises use a smart device guaranteeing quality and durability as a device, issues about quality of the device may be alleviated.

The server 310 may include a transportation fare processing server. In addition, the server 310 may include a local and remote operation server including information on payment and recharging details, and fare information corresponding to each of a bus application, a railroad application, and a taxi application, among applications installed in the payment device 330. The server 310 may interwork with the private application store 320 to update the application of the payment device 330 with a parameter including changes in the fare information.

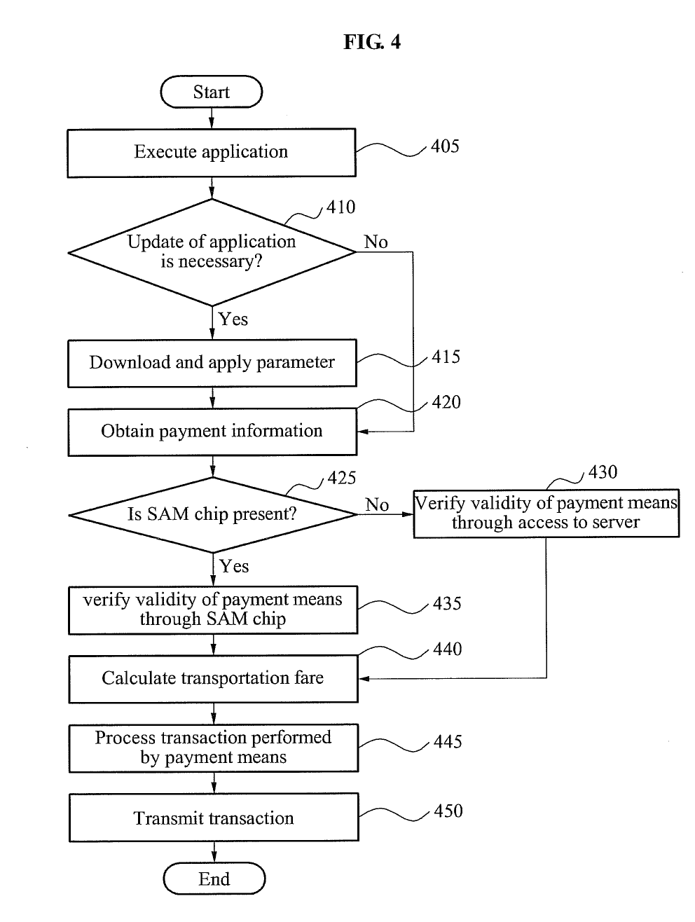

FIG. 4 is a flowchart illustrating a transportation fare processing method in a transportation fare processing system according to an embodiment of the present invention.

Referring to FIG. 4, in operation 405, an application suitable for an environment of a service provider, among applications, for example, a bus application, a railroad application, a taxi application, and a boat application, may be executed.

In operation 410, whether the application is to be updated may be determined based on an indicator indicating that an update of the application is necessary.

When an indicator indicating that an update of the application is necessary is generated, and the service provider recognizes the indicator and updates the corresponding application, a parameter may be downloaded from a private application store via a public communication network, and applied to the application, in operation 415.

In operation 420, payment information may be obtained from a payment means of a user using a communication interface supported by a payment device with a tag interface of the service provider. The payment information may include a transaction performed by the payment means of the user.

In this instance, the communication interface used when the payment means is tagged to the payment device may select one of an RFID scheme and an NFC scheme, and perform the selected scheme. The RFID scheme refers to a scheme of reading stored data from a device including a semiconductor chip using a radio frequency in a contactless manner. The NFC scheme refers to a scheme of recognizing stored data from a device including a semiconductor chip using a radio frequency in a contactless manner within a short distance, for example, 20 centimeters (cm), and performing bidirectional communication of reading and writing.

In operation 425, whether a SAM chip configured to authenticate the payment means is provided in the payment device to which the payment means is tagged may be determined based on the obtained payment information. When a SAM chip is present in the payment device, a validity of the payment means may be verified through the SAM chip, in operation 435.

Conversely, when a SAM chip is absent in the payment device, the validity of the payment means may be verified through an access to the server, in operation 430.

In operation 440, a transportation fare may be calculated based on a parameter applied to the application. In a case of the bus application or the railroad application, the transportation fare may be calculated based on information on a departure station and an arrival station of the user. In a case of the taxi application, the transportation fare may be calculated based on a unit price per distance, and a travel distance of a taxi.

In operation 445, a transaction performed by the payment means may be processed based on the calculated transportation fare. The transaction performed by the payment means may include a transaction performed by a transportation card.

In operation 450, the processed transaction may be uploaded to the server via the public communication network.

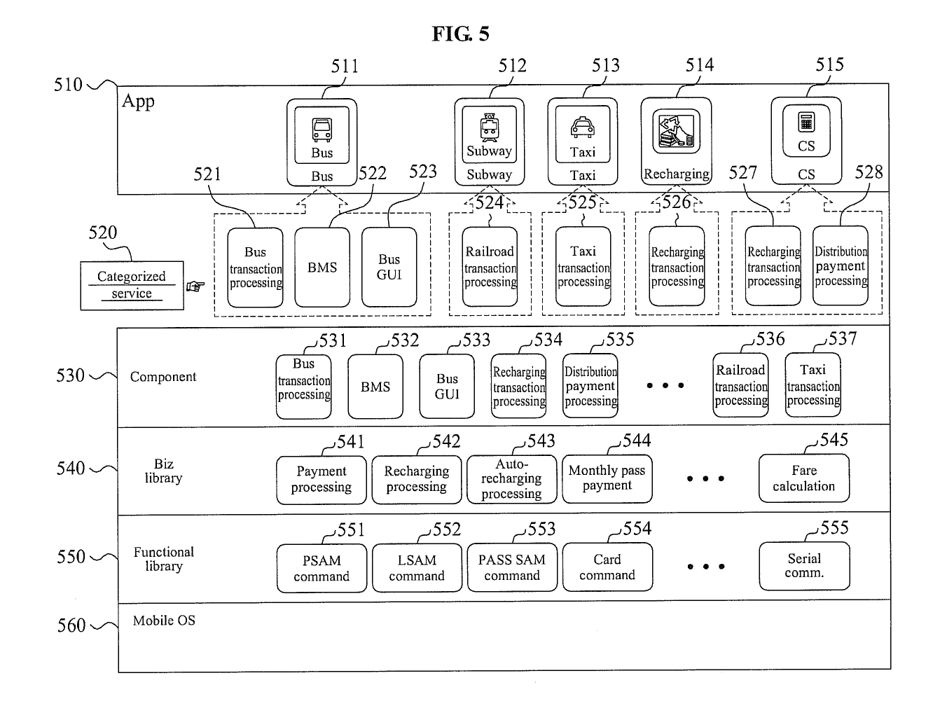

FIG. 5 is a diagram illustrating a configuration of an application 510 installed in a payment device with a tag interface in a transportation fare processing system according to an embodiment of the present invention.

Referring to FIG. 5, the application 510 may be installed in the payment device. The application 510 may include transportation applications, in particular, a bus application 511, a railroad application 512, and a taxi application 513, a recharging application 514, and a distribution fare processing application 515, for example, for a convenience store (CS). The bus application 511, the railroad application 512, the taxi application 513, the recharging application 514, and the distribution fare processing application 515 may have respective category services 520 to be provided to a user. Each category service 520 may include components 530 to provide functions for each service.

The bus application 511 may include a bus transaction processing category 521, a bus management system (BMS) category 522, and a bus graphical user interface (GUI) category 523, and a bus transaction processing component 531, a BMS component 532, and a bus GUI component 533 corresponding respectively to the bus transaction processing category 521, the BMS category 522, and the bus GUI category 523. The railroad application 512 may include a railroad transaction processing category 524, and a corresponding railroad transaction processing component 536. The taxi application 513 may include a taxi transaction processing category 525, and a corresponding taxi transaction processing component 537. The recharging application 514 may include a recharging transaction processing category 526, and a corresponding recharging transaction processing component 534. The distribution fare processing application 515 may include a recharging transaction processing category 527 and a distribution payment processing category 528, and the recharging transaction processing component 534 and a recharging transaction processing component 535 corresponding respectively to the recharging transaction processing category 527 and the distribution payment processing category 528. A BMS component may provide vehicle scheduling information, and a GUI component may provide a GUI for a driver. Here, the GUI component may include the bus GUI component 533. A transaction processing component may process a fare, and may include the bus transaction processing component 533, the distribution payment processing component 535, the railroad transaction processing component 536, and the taxi transaction processing component 537.

In the configuration of the application 510, each component 530 may include business (biz) libraries 540 to perform components. Each biz library may be also referred to as a library. For example, a payment processing biz library may be referred to as a payment processing library.

The biz libraries 540 may provide a service requested by each component. For example, the bus transaction processing component 531 may include a payment processing biz library 541 to perform a deduction of a fare paid by a T-money card, an automatic recharging processing biz library 543 to increase a balance to a predetermined amount when the balance of a T-money card is below a predetermined level, and a fare calculation biz library 543 corresponding to a calculation logic of a fare to be paid for use of transportation.

The recharging transaction processing component 534 may include a recharging processing biz library 542. The distribution payment processing component 535 may include the payment processing biz library 541. The railroad transaction processing component 536 may include the payment processing biz library 541, the automatic recharging processing biz library 543, a monthly pass payment biz library 544, and the fare calculation biz library 545. The taxi transaction processing component 537 may include the payment processing biz library 541, and the fare calculation biz library 545.

In this instance, the components 530 may include at least one common biz library 540.

Each biz library 540 may include functional libraries 550 corresponding to a set of commands to perform an actual processing process. A PSAM command set 551 for payment processing may be included in the payment processing biz library 541, the monthly pass payment biz library 544, and the fare calculation biz library 545. An LSAM command set 552 for recharging processing may be included in the recharging processing biz library 542, and the automatic recharging processing biz library 543. A PASS SAM command set 553 for charging a monthly pass may be included in the recharging processing biz library 542. A card command set 554 may be included in the payment processing biz library 541, the recharging processing biz library 542, the automatic recharging processing biz library 543, and the monthly pass payment biz library 544. A serial communication command set 555 may be included in the bus transaction processing component 531, the railroad transaction processing component 536, and the taxi transaction processing component 537, for providing the communication interface of the payment device and a payment means of a user.

The following Table 1 may provide detailed descriptions of the biz libraries and the command sets.

TABLE 1

| Name | Description |
|---|---|
| Payment processing | Deduction of fare paid by T-money card |
| Recharging processing | Increase of balance of T-money card |
| Auto-recharging | Increase of balance to predetermined |
| processing | amount when balance of T-money card is |
| | below predetermined level |
| Monthly pass payment | Payment for monthly pass used for |
| | railroad |
| Fare calculation | Calculation logic of fare to be paid |
| PSAM command set | Set of SAM commands for payment |
| | processing |
| LSAM command set | Set of SAM commands for recharging |
| | processing |
| PASS SAM command | Set of SAM commands for recharging |
| set | monthly pass |
| Card command set | Set of commands for T-money card |
| Serial communication | Set of commands for communication |
| command set | interface module, for example, RS232/485 |

According to the present embodiment, the applications 510 may have at least one common biz library 540, and each biz library 540 may have at least one common command set corresponding to the functional library 550. Accordingly, an application suitable for an environment of a service provider may be developed and corrected readily. For example, applications corresponding respectively to at least two different forms of transportation, for example, a bus, a railroad, a taxi, a boat, and the like, may include the payment processing biz library 541 in common.

The command sets 550 may be applied to the payment device and thus, the command sets 550 may be operated and generated on a mobile operating system 560.

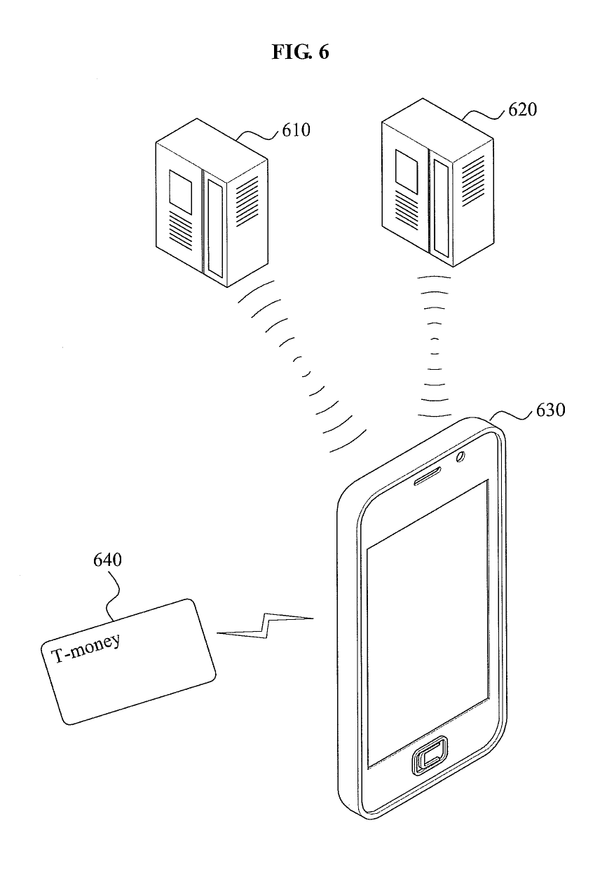

FIG. 6 is a diagram illustrating a distribution fare processing system according to an embodiment of the present invention.

Referring to FIG. 6, the distribution fare processing system may include a center server 610, a private application store 620, a payment device 630 with a tag interface of a service provider to which a payment means 640 of a user is tagged, and the payment means 640.

The payment device 630 may be applied to a mobile payment device or a distribution store. A distribution fare processing application may be installed in the payment device 630 through the private application store 620.

The distribution fare processing system may use a transportation card as the payment means 640 of the user, thereby employing a distribution fare processing method similar to the transportation fare processing method performed by the transportation fare processing system of FIG. 4.

In particular, the distribution fare processing application may be executed. Whether the distribution fare processing application is to be updated may be determined based on an indicator indicating that an update of the distribution fare processing application is necessary. When the indicator indicating that an update of the distribution fare processing application is necessary is generated, and the service provider recognizes the indicator and updates the distribution fare processing application, a parameter may be downloaded from the private application store 620 via a public communication network and applied to the distribution fare processing application. Payment information may be obtained from the payment means 640 using a communication interface supported by the payment device 630. The payment information may include a transaction performed by a transportation card. In addition, whether a SAM chip configured to authenticate the payment means 640 is present may be determined based on the obtained payment information. When a SAM chip is present, a validity of the payment means 640 may be verified through the SAM chip.

Conversely, when a SAM chip is absent in the payment device 630, a validity of the payment means 640 may be verified through an access to the center server 610.

The distribution fare processing method according to the present embodiment may calculate a distribution fare based on the parameter applied to the distribution fare processing application. A transaction related to the payment information may be calculated and updated based on the calculated distribution fare. The transaction related to the payment information may include a transaction performed by the transportation card.

The transaction may be uploaded to the center server 610 via the public communication network.

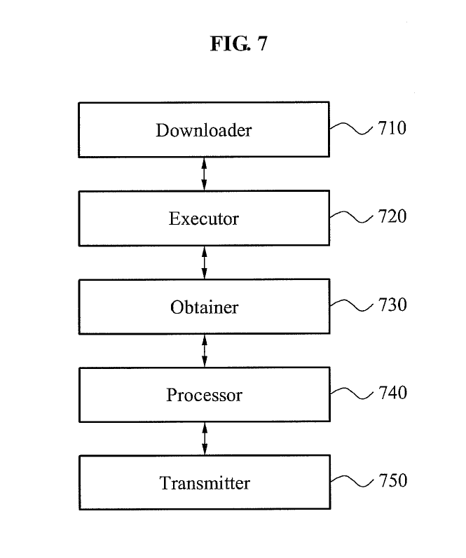

FIG. 7 is a block diagram illustrating a payment device with a tag interface according to an embodiment of the present invention.

Referring to FIG. 7, the payment device may include a downloader 710, an executor 720, an obtainer 730, a processor 740, and a transmitter 750.

The downloader 710 may download a parameter requested by an application from a private application store via a public communication network.

The executor 720 may execute the application on an operating system of the payment device.

The obtainer 730 may obtain payment information from a payment means of a user using a communication interface supported by the payment device.

The processor 740 may process a transaction performed by the payment means based on the payment information, in response to an execution of the application. The processor 740 may calculate a transportation fare based on a parameter applied to the application, and process the transaction performed by the payment means based on the calculated transportation fare.

The transmitter 750 may transmit the processed transaction to a server.

The descriptions provided with reference to FIGS. 1 through 6 may be applied to each component of the payment device of FIG. 7 and thus, a detailed description will be omitted for conciseness.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more non-transitory computer readable recording mediums.

The non-transitory computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, and optical data storage devices. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A transportation fare processing method of a payment device with a tag interface, the method comprising:
executing an application on an operating system of the payment device;
obtaining payment information from a payment means of a user using a communication interface supported by the payment device;
processing a transaction performed by the payment means based on the payment information, in response to an execution of the application; and
transmitting the processed transaction to a server.

2. The method of claim 1, wherein the processing comprises:
calculating a transportation fare based on a parameter applied to the application; and
processing the transaction performed by the payment means based on the calculated transportation fare.

3. The method of claim 2, wherein the parameter comprises at least one of information on a basic unit fare with respect to a form of transportation, a discount rate for each type of user, a transfer discount policy, and a fare calculation rule.

4. The method of claim 1, wherein the application comprises at least one of a bus management system (BMS) component to provide vehicle scheduling information, a graphical user interface (GUI) component to provide a GUI for a driver, and a transaction processing component to process a fare.

5. The method of claim 4, wherein the transaction processing component calculates a fare based on information on a departure station and an arrival station of the user, and processes a transaction of the transportation fare.

6. The method of claim 1, further comprising:
downloading a parameter requested by the application from a private application store via a public communication network; and
applying the downloaded parameter to the application.

7. The method of claim 6, further comprising:
generating an indicator to indicate that an update of the application is necessary.

8. The method of claim 1, wherein the obtaining comprises obtaining the payment information from the payment means, using a radio frequency identification (RFID) interface or a near field communication (NFC) interface.

9. The method of claim 8, further comprising:
verifying a validity of the payment means based on the payment information.

10. The method of claim 9, wherein the verifying comprises one of:
verifying the validity of the payment means, using a secure application module (SAM) provided in the payment means to authenticate the payment means, and
verifying the validity of the payment means through the server corresponding to the application.

11. The method of claim 1, wherein the application comprises a common payment processing library corresponding to different forms of transportation.

12. A non-transitory computer-readable medium comprising a program for instructing a computer to perform the method of claim 1.

13. A payment device with a tag interface for transportation fare processing, the device comprising:
an executor to execute an application on an operating system of the payment device;
an obtainer to obtain payment information from a payment means of a user using a communication interface supported by the payment device;
a processor to process a transaction performed by the payment means based on the payment information, in response to an execution of the application; and
a transmitter to transmit the processed transaction to a server.

14. The device of claim 13, wherein the processor calculates a transportation fare based on a parameter applied to the application, and processes the transaction performed by the payment means based on the calculated transportation fare.

15. The device of claim 14, wherein the parameter comprises at least one of information on a basic unit fare with respect to a form of transportation, a discount rate for each type of user, a transfer discount policy, and a fare calculation rule.

16. The device of claim 13, further comprising:
a downloader to download a parameter requested by the application from a private application store via a public communication network,
wherein the processor applies the downloaded parameter to the application and processes the transaction performed by the payment means using the application.

17. The device of claim 13, wherein the application comprises a common payment processing library corresponding to different forms of transportation.

18. The device of claim 13, wherein the payment device comprises at least one of a point of sale (POS) device, a smart phone, a smart tablet personal computer (PC), and a personal digital assistant (PDA) device.

19. The device of claim 13, wherein the payment means of the user comprises at least one of a transportation card, a near field communication (NFC) chip, and a radio frequency (RF) chip.
